(19) United States
(12) Patent Application Publication
(10) Pub. No.: US 2019/0195168 A1
(43) Pub. Date: Jun. 27, 2019

(54) BURIED STRUCTURE OF CAST-IRON INSERT FOR ENGINE BED PLATE AND METHOD THEREFOR

(71) Applicants: Hyundai Motor Company, Seoul (KR); Kia Motors Corporation, Seoul (KR)

(72) Inventor: Byung-Hyun LEE, Bucheon-si (KR)

(73) Assignees: Hyundai Motor Company, Seoul (KR); Kia Motors Corporation, Seoul (KR)

(21) Appl. No.: 16/141,088

(22) Filed: Sep. 25, 2018

(30) Foreign Application Priority Data
Dec. 27, 2017 (KR) 10-2017-0181244

(51) Int. Cl. F02F 7/00

(52) U.S. Cl. CPC F02F 7/0053; F02F 2200/06; F02F 7/0085

(57) ABSTRACT

A buried structure of a cast-iron insert for an engine bed plate, the structure may include a body frame formed of aluminum, and a plurality of supports, wherein the cast-iron insert is integrally cast with the each of the plurality of supports to form the buried structure, and the cast-iron insert has a protruding portion which is exposed at a position supporting a thrust bearing of each of the plurality of supports.

### CROSS-REFERENCE TO RELATED APPLICATIONS

The present application claims priority to Korean Patent Application No. 10-2017-0181244, filed on Dec. 27, 2017, the entire contents of which is incorporated herein for all purposes by this reference.

### BACKGROUND OF THE INVENTION

### Field of the Invention

The present invention relates to a buried structure of a cast-iron insert for an engine bed plate and a method therefor. More particularly, it relates to a buried structure of a cast-iron insert and a method therefor, which are configured for preventing depression of a portion of an engine bed plate, the portion being configured to support a thrust bearing.

### Description of Related Art

FIG. 1 is a diagram illustrating a buried structure of a cast-iron insert for an engine bed plate according to a related art.

Referring to FIG. 1, a conventional engine bed plate 1 includes a main body frame 10 formed of aluminum and a plurality of supports 20 configured to support a crankshaft, and each of the plurality of supports 20 has a structure in which a cast-iron insert 30 is integrally cast and buried to enhance strength of the plurality of supports 20.

However, in the above-described buried structure of a cast-iron insert for an engine bed plate according to the related art, since the cast-iron insert 30 is entirely completely buried in each of the plurality of supports 20 of the engine bed plate 1, a portion 21 configured to support a thrust bearing 40 is still formed of an aluminum material instead of cast-iron such that there is a problem in that the portion 21 is easily depressed by a weight of the thrust bearing 40.

The information disclosed in this Background of the Invention section is only for enhancement of understanding of the general background of the invention and may not be taken as an acknowledgement or any form of suggestion that this information forms the prior art already known to a person skilled in the art.

### BRIEF SUMMARY

Various aspects of the present invention are directed to providing a buried structure of a cast-iron insert for an engine bed plate and a method therefor, which are configured for preventing depression of a portion of an engine bed plate, the portion being configured to support a thrust bearing.

Other objects and advantages of the present invention may be understood by the following description and become apparent with reference to the exemplary embodiments of the present invention. Also, it is obvious to those skilled in the art to which the present invention pertains that the objects and advantages of the present invention may be realized by the means as claimed and combinations thereof.

In accordance with various exemplary embodiments of the present invention, a buried structure of a cast-iron insert for an engine bed plate, which may include a body frame formed of aluminum, and a plurality of supports, wherein the cast-iron insert is integrally cast with the each of the plurality of supports to form the buried structure, and the cast-iron insert has a protruding portion which is exposed at a position supporting a thrust bearing of each of the plurality of supports.

The protruding portion may have a shape protruding from a main body of the cast-iron insert to a side surface of the main body.

A surface of the protruding portion may be located at a plane coplanar with a side surface of each of the plurality of supports.

The main body of the cast-iron insert may be buried in an internal of each of the plurality of supports.

The main body of the cast-iron insert may have a shape of a lattice structure.

In accordance with various exemplary embodiments of the present invention, a method for burying a cast-iron insert for an engine plate having a buried structure, which may include a body frame formed of aluminum and a plurality of supports and in which the cast-iron insert is integrally cast with the each of the plurality of supports to form the buried structure, the method including casting the cast-iron insert, at which a protruding portion configured to support a thrust bearing, integrally with the engine bed plate including aluminum, and processing the protruding portion to be exposed to a surface of each of the plurality of supports of the engine bed plate.

The casting may include locating the protruding portion at a portion supporting the thrust bearing of each of the plurality of supports.

The processing may include forming a surface of the protruding portion at a plane coplanar with a side surface of the plurality of supports.

In accordance with exemplary embodiments of the present invention, it is possible to provide an effect of preventing depression of an engine bed plate due to a weight of a thrust bearing through only a minimum increase in weight by burying a cast-iron insert in the engine bed plate to expose only a portion configured to support the thrust bearing.

The methods and apparatuses of the present invention have other features and advantages which will be apparent from or are set forth in more detail in the accompanying drawings, which are incorporated herein, and the following Detailed Description, which together serve to explain certain principles of the present invention.

### BRIEF DESCRIPTION OF THE DRAWINGS

FIG. 1 is a diagram illustrating a buried structure of a cast-iron insert for an engine bed plate according to a related art.

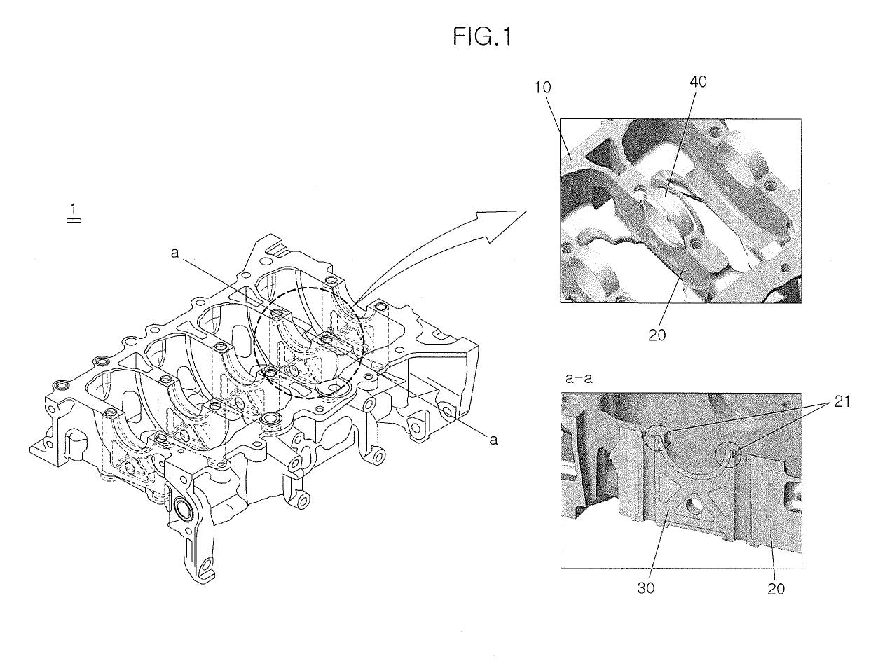

FIG. 2 is a partially transparent perspective view illustrating a buried structure of a cast-iron insert for an engine bed plate according to an exemplary embodiment of the present invention.

FIG. 3 is a partial perspective view illustrating the engine bed plate in which the cast-iron insert is buried according to an exemplary embodiment of the present invention.

It may be understood that the appended drawings are not necessarily to scale, presenting a somewhat simplified representation of various features illustrative of the basic principles of the present invention. The specific design features of the present invention as included herein, including, for example, specific dimensions, orientations, locations, and shapes will be determined in part by the particularly intended application and use environment.

In the figures, reference numbers refer to the same or equivalent parts of the present invention throughout the several figures of the drawing.

### DETAILED DESCRIPTION

Reference will now be made in detail to various embodiments of the present invention(s), examples of which are illustrated in the accompanying drawings and described below. While the present invention(s) will be described in conjunction with exemplary embodiments of the present invention, it will be understood that the present description is not intended to limit the present invention(s) to those exemplary embodiments. On the other hand, the present invention(s) is/are intended to cover not only the exemplary embodiments of the present invention, but also various alternatives, modifications, equivalents and other embodiments, which may be included within the spirit and scope of the present invention as defined by the appended claims.

Hereinafter, a buried structure of a cast-iron insert for an engine bed plate and a method therefore according to an exemplary embodiment of the present invention will be described in detail with reference to the accompanying drawings. However, if it is determined that known functions and configurations may unnecessarily obscure the gist of the present invention, detailed descriptions thereof will be omitted.

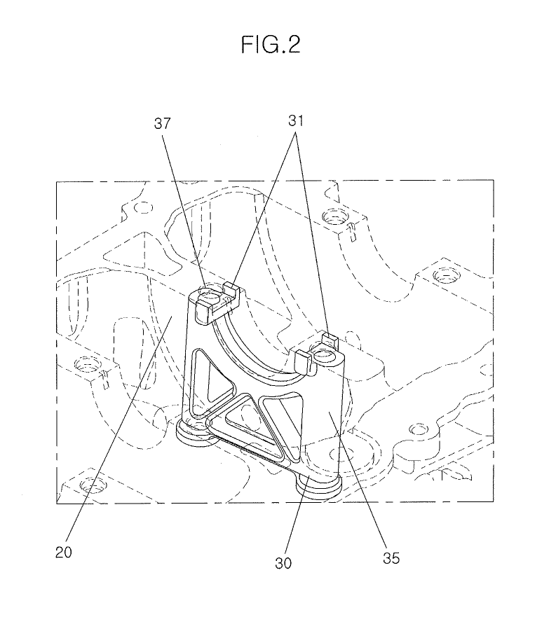

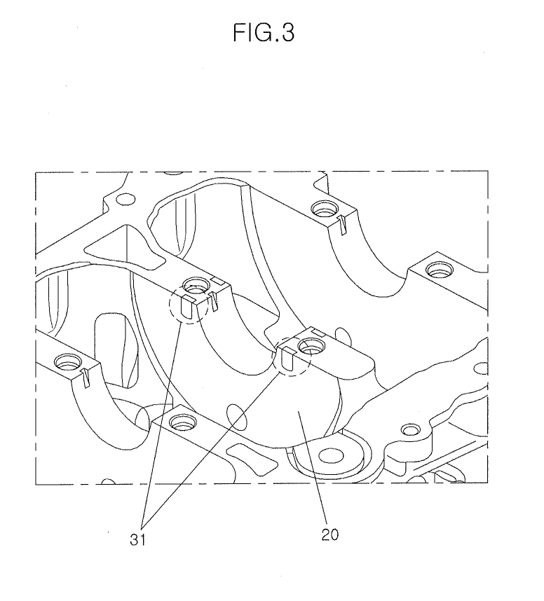

FIG. 2 is a partially transparent perspective view illustrating a buried structure of a cast-iron insert for an engine bed plate according to an exemplary embodiment of the present invention, and FIG. 3 is a partial perspective view illustrating the engine bed plate in which the cast-iron insert is buried according to an exemplary embodiment of the present invention.

Referring to FIG. 2, a protruding portion 31 configured to be externally exposed of a support 20 of an engine bed plate 1 is formed at a cast-iron insert 30 buried in the engine bed plate 1 according to an exemplary embodiment of the present invention when the cast-iron insert 30 is buried in the engine bed plate 1. The protruding portion 31 has a shape protruding from a main body 35 of the cast-iron insert 30 to a side surface of the main body 35 such that the protruding portion 31 may be externally exposed when buried in the engine bed plate 1.

In an exemplary embodiment of the present invention, the protruding portion 31 may be formed at a side of the cast-iron insert 30 in C-shape.

Meanwhile, the main body 35 of the cast-iron insert 30 is completely buried in the support 20, and as shown in FIG. 2, the main body 35 of the cast-iron insert 30 has a shape of a lattice structure for increasing rigidity but it is not limited thereto and may have various shapes.

Referring to FIG. 3, the protruding portion 31 is formed to be located at a portion for supporting a thrust bearing 40 when the cast-iron insert 30 is buried in the support 20 of the engine bed plate 1, and a surface of the protruding portion 31 is formed to be coplanar with a side surface of the support 20.

In an exemplary embodiment of the present invention, a pair of protruding portions 31 is disposed such that the bolt hole 37 for mounting the thrust bearing 40 is positioned between the protruding portions 31.

The buried structure of a cast-iron inert for an engine bed plate according to an exemplary embodiment of the present invention is formed such that the cast-iron insert 30 at which the protruding portion 31 is formed is integrally cast with the engine bed plate 1 including an aluminum material and then is processed to expose the protruding portion 31 to a plane coplanar with the side surface of the support 20.

In accordance with exemplary embodiments of the present invention, it is possible to prevent depression of an engine bed plate due to a weight of a thrust bearing through only a minimum increase in weight by burying a cast-iron insert in the engine bed plate to expose only a portion configured to support the thrust bearing.

For convenience in explanation and accurate definition in the appended claims, the terms “upper”, “lower”, “inner”, “outer”, “up”, “down”, “upper”, “lower”, “upwards”, “downwards”, “front”, “rear”, “back”, “inside”, “outside”, “inwardly”, “outwardly”, “internal”, “external”, “inner”, “outer”, “forwards”, and “backwards” are used to describe features of the exemplary embodiments with reference to the positions of such features as displayed in the figures.

The foregoing descriptions of specific exemplary embodiments of the present invention have been presented for purposes of illustration and description. They are not intended to be exhaustive or to limit the present invention to the precise forms disclosed, and obviously many modifications and variations are possible in light of the above teachings. The exemplary embodiments were chosen and described to explain certain principles of the present invention and their practical application, to enable others skilled in the art to make and utilize various exemplary embodiments of the present invention, as well as various alternatives and modifications thereof. It is intended that the scope of the present invention be defined by the Claims appended hereto and their equivalents.

What is claimed is:

1. A buried structure of a cast-iron insert for an engine bed plate, the structure comprising:
a body frame formed of aluminum; and
a plurality of supports,
wherein the cast-iron insert is integrally cast with each of the plurality of supports to form the buried structure, and
wherein the cast-iron insert has a protruding portion which is exposed out of the supports at a position supporting a thrust bearing of each of the plurality of supports.

2. The buried structure of claim 1, wherein the protruding portion has a shape protruding from a main body of the cast-iron insert to a side surface of the main body.

3. The buried structure of claim 2, wherein a surface of the protruding portion is located at a plane coplanar with a side surface of each of the plurality of supports.

4. The buried structure of claim 1, wherein the main body of the cast-iron insert is buried in an internal of each of the plurality of supports.

5. The buried structure of claim 4, wherein the main body of the cast-iron insert has a shape of a lattice structure.

6. The buried structure of claim 1, wherein a pair of protruding portions is disposed such that a bolt hole for mounting the thrust bearing is positioned between the pair of the protruding portions.

7. A method for burying a cast-iron insert for an engine bed plate having a buried structure, which includes a body frame formed of aluminum and a plurality of supports and in which the cast-iron insert is integrally cast with each of the plurality of supports to form the buried structure, the method including:
casting the cast-iron insert, at which a protruding portion is configured to support a thrust bearing, integrally with the engine bed plate including aluminum; and
processing the protruding portion to be exposed out of the supports to a surface of each of the plurality of supports of the engine bed plate.

8. The method of claim 6, wherein the casting includes locating the protruding portion at a portion supporting the thrust bearing of each of the plurality of supports.

9. The method of claim 6, wherein the processing includes forming a surface of the protruding portion at a plane coplanar with a side surface of the plurality of supports.

10. The method of claim 7, wherein a pair of protruding portions is disposed such that a bolt hole for mounting the thrust bearing is positioned between the pair of the protruding portions.
